(19) United States
(12) Patent Application Publication
(10) Pub. No.: US 2007/0161443 A1
(43) Pub. Date: Jul. 12, 2007

(54) Wear resistant split sprocket for modular link belt systems

(76) Inventor: Michal Krisl, Basel (CH)

Correspondence Address: HODGSON RUSS LLP;THE GUARANTY BUILDING, 140 PEARL STREET, SUITE 100, BUFFALO, NY, 14202-4040, US

(21) Appl. No.: 11/329,533

(22) Filed: Jan. 11, 2006

(51) Int. Cl. F16H 55/12

(52) U.S. Cl. 474/95

(57) ABSTRACT

A split sprocket assembly with a pair of sprocket body members constructed of a first material and a plurality of tooth insert members constructed of a stronger wear resistant material. The sprocket body members capable of aligning around a shaft and being connected together by attachment of the tooth insert members around the sprocket body members in end-to-end fashion.

### FIELD OF INVENTION

The present invention relates to modular conveying apparatus.

### BACKGROUND OF THE INVENTION

Because they do not corrode, are lightweight, and are easy to clean, unlike metal conveyor belts, plastic conveyor belts are used widely, especially in conveying food products. Modular plastic conveyor belts are made up of molded plastic modular links, or belt modules, that can be arranged side-by-side in rows of selectable width. A series of spaced part link ends extending from each side of the modules include aligned apertures to accommodate a pivot rod. The link ends along one end of a row of modules are interconnected with the link ends of an adjacent row. A pivot rod journaled in the aligned apertures of the side-by-side and end-to-end connected modules forms a hinge between adjacent rows. Rows of belt modules are then connected together to form an endless conveyor belt capable of articulating about a drive sprocket.

Most sprockets used to drive modular belts are produced from plastics, either molded or machined. Under very abrasive conditions the plastic sprocket teeth tend to wear very quickly. Accordingly, it has been known to use sprockets made at least in part of metals such as steel. Some examples are disclosed in U.S. Pat. Nos. 5,074,406 and 5,279,526.

For convenience, it has also been known to provide a split sprocket capable of attaching around an axle instead of having to be slid off the end of the axle which can require time-consuming disassembly of the drive system.

Accordingly, what is needed is an improved design for a split sprocket having teeth inserts for extended wear.

### SUMMARY OF THE INVENTION

The present invention meets the above-described need by providing a split sprocket assembly with teeth inserts.

### BRIEF DESCRIPTION OF THE DRAWINGS

The invention is illustrated in the drawings in which like reference characters designate the same or similar parts throughout the figures of which:

FIG. 1 is an exploded perspective view of the split sprocket assembly in accordance with the present invention;

FIG. 2 is a perspective view of the two halves of the split sprocket assembly disposed in spaced apart relation;

FIG. 3 is a perspective view of the split sprocket assembly in the assembled position;

FIG. 4 is a side elevational view of the split sprocket assembly of the present invention;

FIG. 5 is a cross-sectional view taken along lines 5-5 of FIG. 4;

FIG. 6 is a cross-sectional view taken along lines 6-6 of FIG. 4;

FIG. 7 is a cross-sectional view taken along lines 7-7 of FIG. 4;

FIG. 8 is an exploded perspective view of an alternate embodiment of the present invention;

FIG. 9 is a perspective view of the alternate embodiment showing the hub connected and the teeth inserts in exploded view;

FIG. 10 is a perspective view of the alternate embodiment in the assembled position;

FIG. 11 is a side elevational view of the alternate embodiment;

FIG. 12 is a cross-sectional view taken along lines 12-12 of FIG. 11;

FIG. 13 is a perspective exploded view of another alternate embodiment of the present invention;

FIG. 14 is a perspective view of the alternate embodiment showing the hub connected and the teeth inserts in exploded view;

FIG. 15 is a perspective view of the second alternative in the assembled position;

FIG. 16 is a side elevational view of the second alternate embodiment; and, FIG. 17 is a cross-sectional view taken along lines 17-17 of FIG. 16.

### DETAILED DESCRIPTION

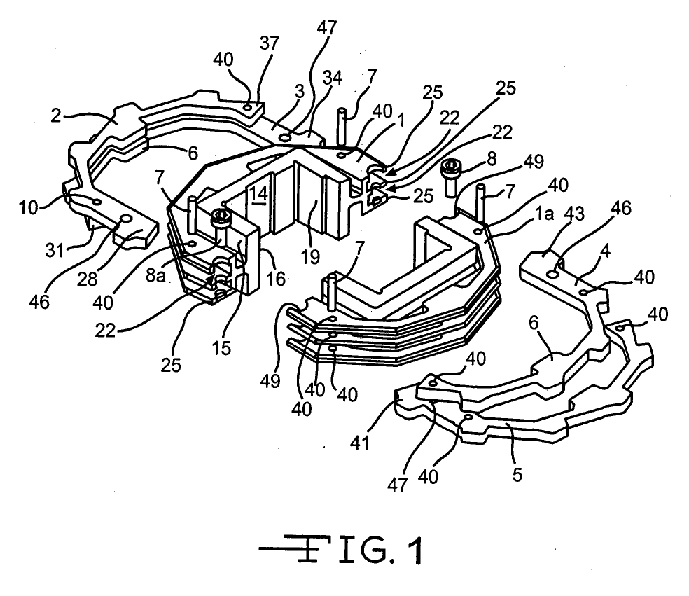

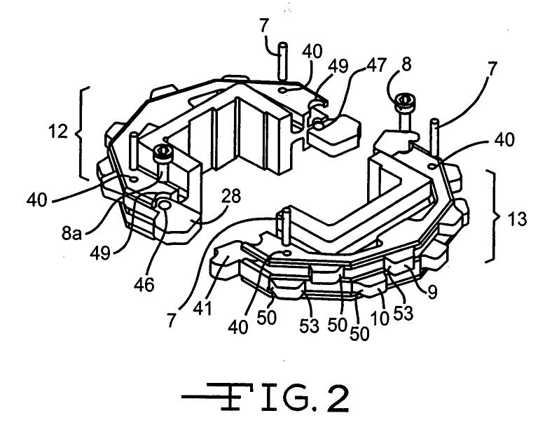

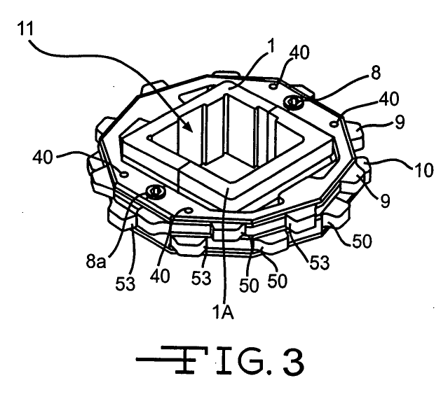

Initially referring to FIGS. 1 and 2, the split sprocket assembly of the present invention includes a pair of sprocket halves 12 and 13 (FIG. 2). The sprocket halves 12 and 13 are preferably primarily constructed of plastic for reduced weight. Each sprocket half 12, 13 forms approximately one-half of the assembled sprocket. As shown in FIG. 3, when the two sprocket halves 12, 13 are connected, they form a central opening 11 for mounting the sprocket assembly onto a shaft (not shown). As shown, the opening 11 is shaped substantially square for receiving a square shaft. Other shapes may also be suitable as will be evident to those of ordinary skill in the art.

Returning to FIG. 1, the two plastic sprocket body members 1 and 1A have a central hub portion 15 with a rear wall 14 and a pair of opposed side walls 16 and 19. The side walls 16 and 19 are disposed in spaced apart relation and the rear wall 14 and side walls 16 and 19 border the opening 11 for the shaft (not shown) when the split sprocket is assembled. The periphery of sprocket body member 1 is provided with channels 22 formed by plates 25 that extend outward from the central hub portion 15. In the example shown, there are three plates 25 extending substantially perpendicular and outward with respect to the central hub portion 15. As a result, parallel channels 22 are formed. Each channel 22 receives a ring segment 2, 3, 4, and 5. The wear resistant ring segments 2, 3, 4, and 5 may be constructed of wear resistant materials including metals such as steel. Depending on the application, the materials may comprise mild steel or stainless steel. Other materials stronger than plastic such as titanium could also be used. The wear resistant materials are not limited to metals and may include other non-metallic materials having wear resistance superior to plastic.

Each ring segment 2, 3, 4, and 5 includes a cam 6 that engages in a corresponding recess 29 (best shown in FIG. 4) in the sprocket body members 1, 1A to transmit the driving torque from the hub to the ring segments with teeth.

Turning to FIG. 2, the two sprocket body members 1, 1A are aligned with the ring segments 2, 3, 4, and 5 by means of locating pins 7 that are inserted through openings 40 in the sprocket body members 1, 1A and the ring segments 2, 3, 4, and 5. Once the openings are placed in registry, insertion of the locating pins 7 fixes the position of all of the parts of the assembly. The sprocket body members 1 and 1A are removably connected by attachment screws 8 and 8A. The attachment screws 8 and 8A hold the ends of ring segments 2, 3, 4, 5 together. As shown, the ring segments 2 and 3 are disposed in overlapping fashion such that one end 28 of ring segment 2 extends beyond the corresponding end 31 of ring segment 3 (best shown in FIG. 1). On the opposite end of ring segment 3, the second end 34 extends beyond the second end 37 of ring segment 2. As shown on the other side of FIG. 1, the ring segments 4 and 5 are arranged in similar fashion such that the end 28 of ring segment 2 can be attached to the end 41 of ring segment 5. Likewise, the second end 34 of ring segment 3 is connected to the end 43 of ring segment 4. The overlapping arrangement allows for registry of openings 46, 47 in the ring segments 2, 3, 4, 5 that receive attachment screws 8 and 8A. One of the openings 46, 47 is threaded and the other opening is larger such that the sprocket halves 12, 13 can be joined by attachment screws 8, 8A without any additional hardware such as nuts.

The sprocket body members 1, 1A have curved openings 49 that provide clearance for inserting the screws 8 and 8A. Also, the curved openings 49 provide a locating function as the attachment screws 8, 8A can only be inserted from the correct side of the sprocket body members 1, 1A. Because the sprocket body members 1 and 1A are constructed of plastic, as described above, it is advantageous to have the attachment screws 8 and 8A engage with the wear resistant ring segments 2, 3, 4, and 5 rather than the sprocket body members 1 and 1A. The forces between the ring segments 2, 3, 4, 5 and the plastic sprocket body members 1, 1A would be transmitted to the bolt hole openings if they were located in the plastic sprocket body members 1, 1A causing wear. By distributing the forces over the plastic body and connecting the attachment screws 8, 8A only to wear resistant parts, the durability of the split sprocket assembly is increased.

As shown in FIGS. 2 and 3, each ring segment 2, 3, 4, and 5 has a plurality of sprocket teeth 9, 10 disposed around its periphery. The sprocket teeth 9, 10 are disposed in pairs on each of ten sides disposed around the sprocket. As shown in FIG. 3, when the sprocket halves are assembled, the split sprocket assembly may form a polygon having a plurality of equal surfaces around the periphery of the assembly. Other shapes may also be suitable as will be evident to those of ordinary skill in the art. The teeth 9, 10 are each formed with a curved end 50 and an angled wall 53. The teeth 9, 10 are designed to drive a modular belt by engagement with either of the ends of the individual belt modules or with a central rib disposed on the underside of the belt module as will be evident to those of ordinary skill in the art. The curved ends 50 of the teeth 9, 10 usually engage with the ends of the individual belt modules because of their position, and the angled wall 53 may engage with the central rib due to its central position.

Turning to FIGS. 3 and 4, the assembled sprocket is shown. In order to install the split sprocket assembly on an axle, the sprocket body members 1, 1A and the corresponding ring segments 2, 3, 4, 5 are fixed together by placing the openings 40 in registry and inserting the locating pins 7. The two pre-assembled sprocket halves 12, 13 are then placed over the shaft (not shown) and pushed together such that the protruding ring segments (best shown in FIG. 2) slide into the corresponding grooves and give positive-fit assembly.

The sprocket halves 12, 13 are tightly fixed by attachment screws 8, 8A with each attachment screw passing through the opening 46 in one ring segment and engaging with a threaded opening 47 in the corresponding ring segment. The bottom edges 60 of the ring segments 2, 3, 4, 5 are shown in broken lines in 4. As shown in 4, the cam 6 engages in the recess 29 to distribute the torque from the sprocket body members 1, 1A to the teeth 9, 10 of the ring segments.

In FIG. 5, the central hub portion 15 is shown in greater detail. The central hub portion 15 has a wall 14 that extends across the width of the sprocket and borders the central opening 11 for the shaft (not shown). On the side opposite the shaft, a wall 70, which is disposed vertically with respect to the orientation of FIG. 5, extends outward from the wall 14. The wall 70 extends to a wall 73 that extends substantially parallel to wall 14. The wall 73 supports the plates 25 which form the channels 22 for receiving the ring segments 2, 3, 4, 5. In the example shown, there are two channels 22 formed by three plates 25. As will be evident to those of ordinary skill in the art, other numbers of plates 25 may be used to create different numbers of channels 22. With reference to the orientation of FIG. 5, the lower portion of the sprocket is formed in the same manner. This example provides a sprocket having double rows of teeth. The ring segments 2, 3 are shown at the top of the figure, and the ring segments 4, 5 are shown at the bottom of the figure. The cam 6 on ring segments 2, 3, 4, 5 is also shown in FIG. 5.

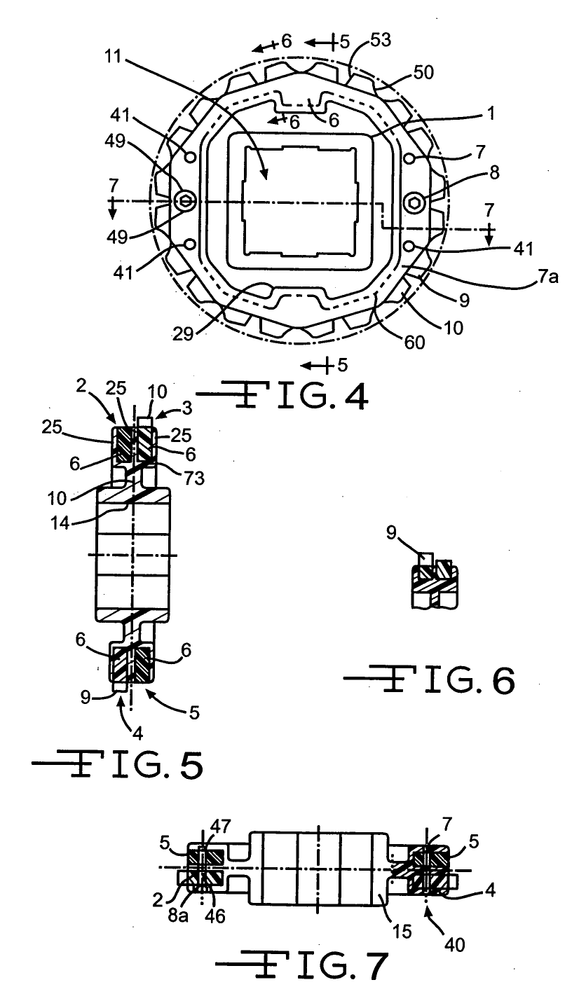

Turning to FIG. 6, the ring segments 2, 3 are shown at a position around the periphery of the sprocket assembly beyond the cam 6. Accordingly, the ring segments 2, 3 do not include the cam 6 and only need to be thick enough to support the tooth 9 shown in the figure.

In FIG. 7, the connection of the two sprocket halves 12, 13 is shown in greater detail. With reference to the left hand side of the figure, the attachment screw 8A extends through opening 46 in ring segment 2 and engages with threaded opening 47 disposed in ring segment 5. Accordingly, the attachment screw 8A does not engage with any plastic parts and the torque is distributed across a larger surface area of the plastic to reduce the wear.

On the right hand side of FIG. 7, the locating pin 7 is shown extending through openings 40 in sprocket body member 1A and ring segments 4, 5. The locating pin 7 provides for preassembly of sprocket half 13 such that the parts are held together prior to placing them around the shaft and connection to sprocket half 12.

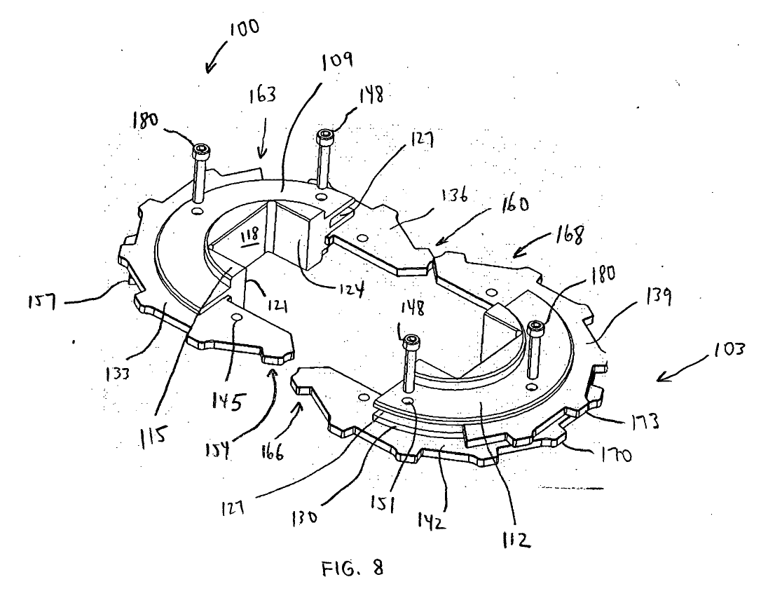

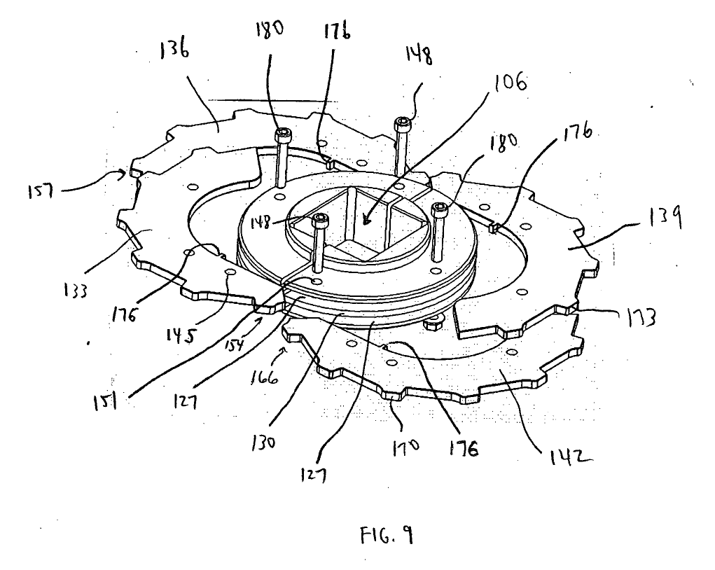

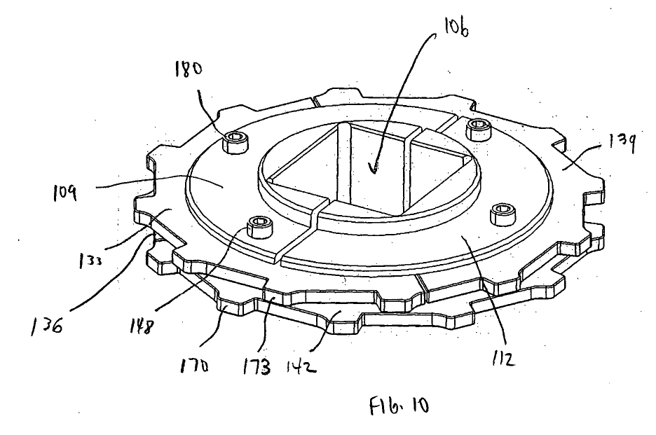

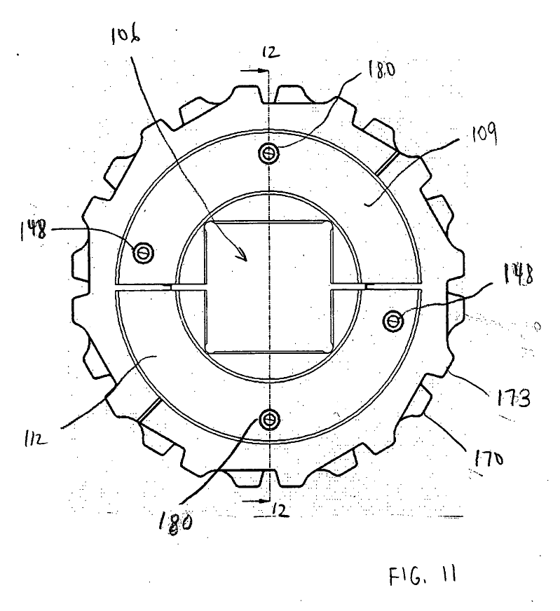

Turning to FIGS. 8 and 9, an alternate embodiment of the split sprocket assembly of the present invention is shown. The alternate embodiment includes a pair of sprocket halves 100 and 103. The sprocket halves 100 and 103 are preferably constructed primarily of plastic materials for reduced weight. Each sprocket half 100, 103 forms approximately one-half of the assembled sprocket. As shown in FIG. 9, when the two sprocket halves 100, 103 are connected, they form a central opening 106 for mounting the sprocket assembly onto a shaft (not shown). As shown, the opening 106 is shaped substantially square for receiving a square shaft. Other shapes may also be suitable as will be evident to those of ordinary skill in the art.

Referring to FIG. 8, two sprocket body members 109, 112 have a central hub portion 115 with a rear wall 118 and a pair of opposed side walls 121 and 124. The side walls 121 and 124 are disposed in spaced apart relation to each other. When the split sprocket is assembled, the rear wall 118 and the side walls 121 and 124 border the opening 106 for the shaft (FIG. 9). The periphery of sprocket body member 109 contains channels 127 formed by plates 130 that extend outward from the central hub portion 115. In the example shown, there are three plates 130 extending substantially perpendicular and outward with respect to the central hub portion 115. As a result, the channels 127 are formed parallel to each other. Each channel 127 receives ring segments 133, 136, 139, and 142. The wear resistant ring segments 133, 136, 139, and 142 may be constructed of wear resistant materials including metals such as steel. Depending on the application, the materials may comprise mild or stainless steel. Other materials stronger than plastic such as titanium could also be used. The wear resistant materials are not limited to metals and may include other non-metallic materials having wear resistance properties superior to plastic.

The central hub 115 can be manufactured by turning and then cutting the part into two sections. Each ring segment 133, 136, 139, and 142 includes openings 145 for fasteners 148 such as screws. The fasteners 148 transmit the driving torque from the hub to the ring segments.

The sprocket body members 109, 112 are aligned with the ring segments 133, 136, 139 and 142 by means of fasteners 148 that are inserted through openings 151 in the sprocket body members 109, 112 and the ring segments 133, 136, 139, and 142. Once the openings are placed in registry, insertion of the fasteners 148 fixes the position of all of the parts of the assembly.

The sprocket body members 109, 112 are removably attached by fasteners 148. The fasteners 148 hold the ends of ring segments 133, 136, 139, and 142 together. As shown, the ring segment 133 and 136 are disposed in overlapping fashion such that one end 154 of ring segment 133 extends beyond the corresponding end 157 of ring segment 136. On the opposite end of ring segment 136, the second end 160 extends beyond the second end 163 of ring segment 133. As shown on the other side of FIG. 9, the ring segments 139, 142 are arranged in similar fashion such that the end 154 of segment 133 can be attached to the end 166 of ring segment 142. Likewise the second end 160 of ring segment 136 is connected to the end 168 of ring segment 139.

The overlapping arrangement allows for registry of the openings in the ring segments and the openings in the sprocket body members 109, 112. Fasteners 148 are disposed through the openings to secure the ring segments 133, 136, 139, 142 to the sprocket body members 109, 112. The fasteners 148 may be secured by nuts or some of the openings can be threaded to eliminate the need for nuts.

As shown in FIGS. 8 and 9, each ring segment 133, 136, 139, and 142 has a plurality of sprocket teeth 170, 173 disposed around its periphery. The teeth 170, 173 are formed as described above in connection with teeth 9, 10. The sprocket teeth 170, 173 are disposed in pairs as best shown in FIG. 11.

As shown in FIG. 9., the ring segments 133, 136, 139, and 142 include a projection 176 that engages with a corresponding recess (not shown) in the sprocket body members 109, 112.

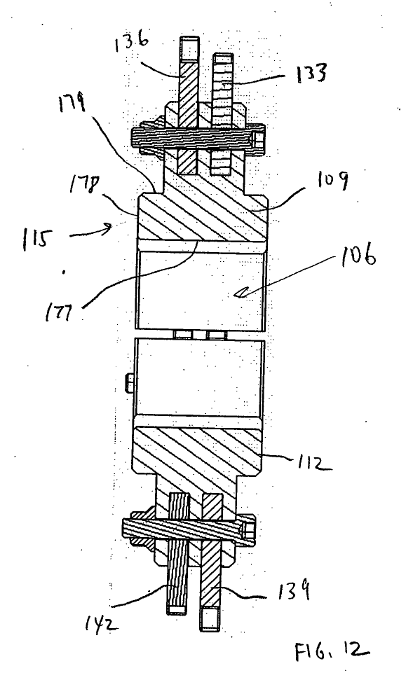

Turning to FIGS. 10-12, the assembled sprocket is shown. In order to install the split sprocket assembly on an axle, the sprocket body members 109, 112, and the corresponding ring segments 133, 136, 139, and 142 are fixed together by placing the openings in registry and inserting the fasteners 180 located on opposite sides of the sprocket to form two pre-assembled sprocket halves. The two pre-assembled sprocket halves are then placed over the shaft (not shown) and pushed together such that the protruding ring segments slide into the corresponding grooves and give positive-fit assembly.

The sprocket halves are tightly fixed by fasteners 148 such as attachment screws with each attachment screw 148 passing through the corresponding openings in the sprocket body members and both ring segments. The projection 176 (FIG. 9) engages in a recess in the sprocket body member to help to distribute the torque from the sprocket body members to the teeth of the ring segments.

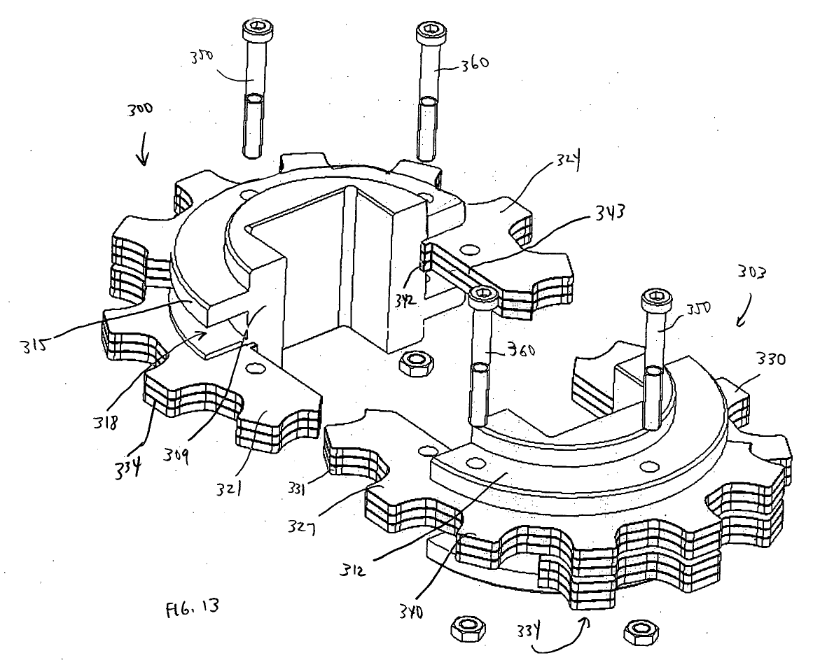

In FIG. 12, the central hub portion is shown in greater detail. The central hub portion 115 has a wall 177 that extends across the width of the sprocket and borders the central opening 106 for the shaft (not shown). A wall 178 which is disposed vertically with respect to the orientation of FIG. 12 extends away from opening 106. The wall 178 extends to a wall 179 that extends substantially parallel to wall 177. The wall 179 supports the plates 130 which form the channels 127 for receiving the ring segments 133, 136, 139, 142. In the example shown, there are two channels formed by three plates. As will be evident to those of ordinary skill in the art, other numbers of plates may be used to create different numbers of channels. With reference to the orientation of FIG. 12, the lower portion of the sprocket is formed in the same manner. This example provides a sprocket having double rows of teeth. The ring segments are shown at the top of the figure, and the ring segments are shown at the bottom of the figure.

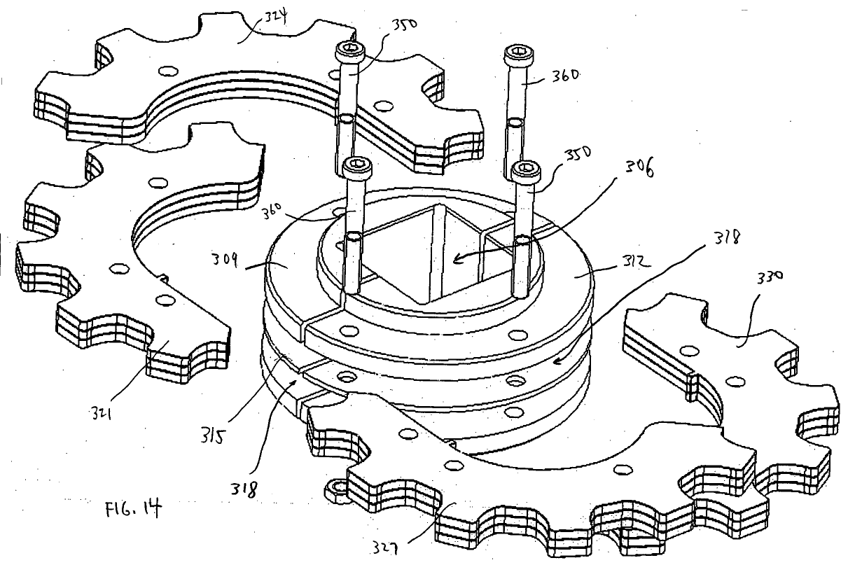

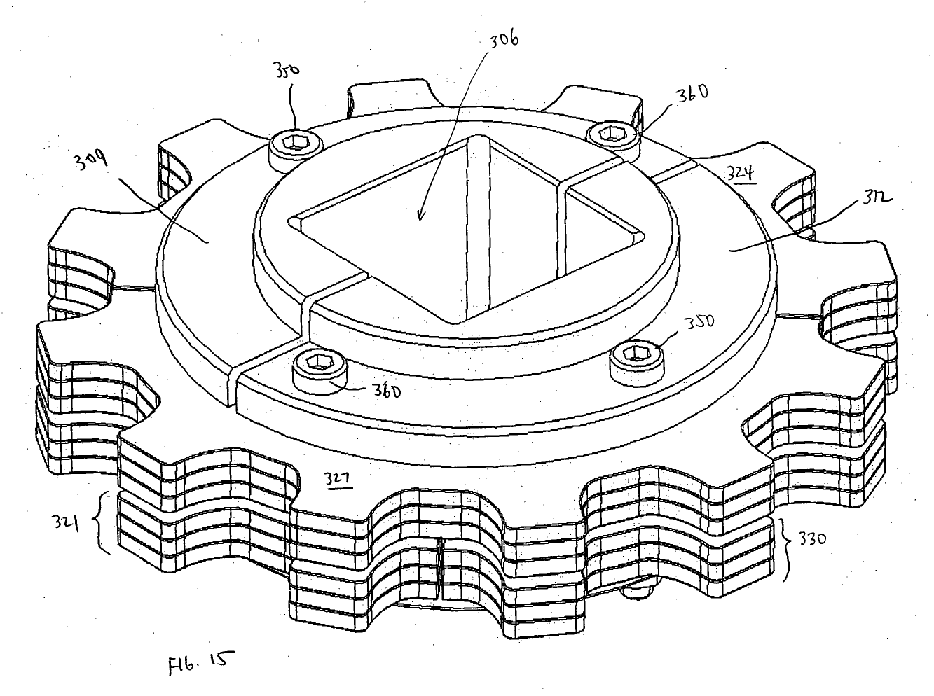

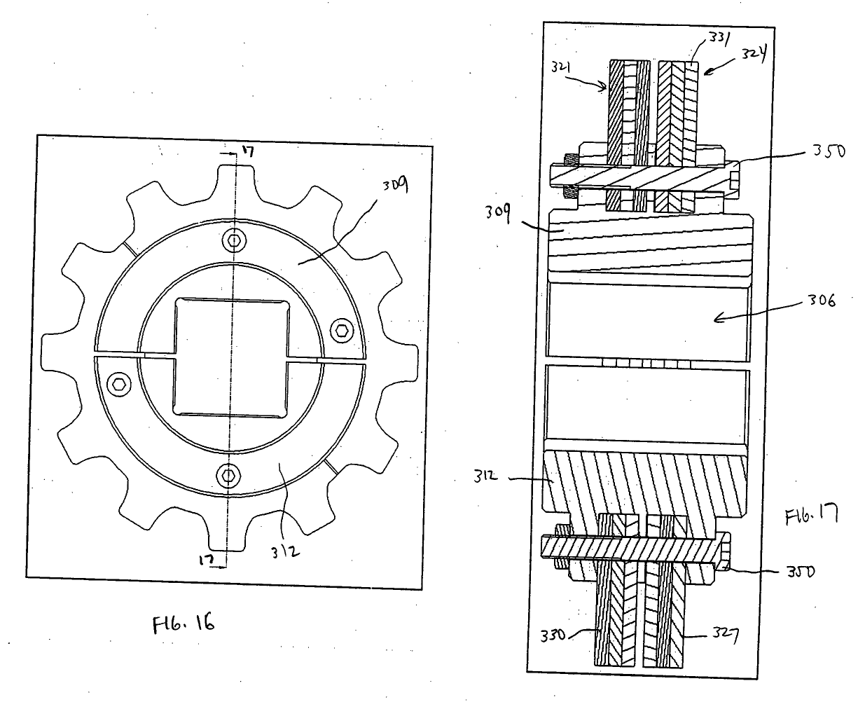

Turning to FIGS. 13-17, a second alternate embodiment of the sprocket assembly is shown. The split sprocket assembly includes a pair of sprocket halves 300 and 303. The sprocket halves 300, 303 are formed by sprocket body members 309 and 312. As shown in FIG. 14, the sprocket body members 309 and 312 join to form an opening 306 for mounting the sprocket assembly on a shaft (not shown). The sprocket body members 309, 312 have plates 315 extending therefrom. Adjacent plates 315 form channels 318 for receiving ring segments 321, 324, 327, and 330. The ring segments 321, 324, 327, 330 are arranged as described above in connection with the second embodiment. In contrast to the previous embodiment, the ring segments are formed from stacks of individual plates 331. In the example shown there are three plates for each ring segment. Other numbers of plates would also be suitable. The plates combine to form ring segments with teeth 334 formed on a first edge 340 and at least one projection 342 formed on a second edge 343. The ring segments are disposed in the channels 318 in the sprocket body members 309, 312. In order to install the split sprocket assembly on a shaft, the sprocket body members 309, 312 and the corresponding ring segments 321, 324, 327, and 330 are fixed together by placing the openings in registry and inserting fasteners 350 such as attachment screws and nuts. The two pre- assembled sprocket halves are then placed over the shaft (not shown) and pushed together such that the protruding ring segments slide into the corresponding grooves and give positive-fit assembly. The sprocket halves 300, 303 are tightly fixed by fasteners 360 passing through the corresponding openings. Projection 342 may be provided to engage with a corresponding recess in the sprocket body 309 to help to distribute the torque from the sprocket body 309 members to the teeth 334 of the ring segments 321, 324, 327, and 330.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims. While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

We claim:

1. A split sprocket assembly, comprising:
at least two sprocket body members having a first side defining a portion of an opening for receiving a shaft and having a second side;
at least two ring segments having a plurality of sprocket teeth disposed along the periphery thereof, each of the at least two ring segments capable of engaging with the second side of the at least two sprocket body members; and,
wherein the at least two sprocket body members are capable of being juxtaposed around the shaft and held together by connection of the at least two ring segments in end-to-end fashion around the at least two sprocket body members.

2. The split sprocket assembly of claim 1, wherein the at least two sprocket body members are constructed of plastic.

3. The split sprocket assembly of claim 1, wherein the at least two ring segments are constructed of metal.

4. The split sprocket assembly of claim 1, wherein at least one groove is disposed on one of the at least two sprocket body members and the at least two ring segments.

5. The split sprocket assembly of claim 4, wherein at least one projection for engaging with the groove is disposed on one of the at least two ring segments and the at least two sprocket body members.

6. The split sprocket assembly of claim 1, further comprising a plurality of walls extending from the at least two sprocket body members, the walls disposed in spaced apart relation.

7. The split sprocket assembly of claim 6, wherein the at least two ring segments are each disposed between adjacent walls.

8. The split sprocket assembly of claim 1, wherein the at least two ring segments comprise a plurality of sprocket teeth extending from a first side.

9. The split sprocket assembly of claim 8, wherein the sprocket teeth extend along the periphery of the at least two ring segments.

10. A split sprocket assembly, comprising:
at least two sprocket body members having a first hub portion with at least one first wall on a first side of the hub portion defining at least a portion of an opening for receiving a shaft, at least two spacer walls extending from a second side of the hub portion disposed opposite from the first side, the at least two spacer walls disposed in spaced apart relation;
at least two ring segments having a plurality of first sprocket teeth, the at least two ring segments each disposed between the at least two spacer walls, each of the ring segments having a first end portion and a second end portion disposed opposite the first end portion; and,
wherein the first and second end portions of each of the ring segments are capable of attaching to the first and second end portions of a ring segment disposed in facing relationship on one of the at least two sprocket body members such that the at least two ring segments hold the at least two sprocket body members together around the shaft.

11. The split sprocket assembly of claim 10, wherein the at least two sprocket body members are plastic.

12. The split sprocket assembly of claim 10, wherein the at least two ring segments are constructed of metal.

13. The split sprocket assembly of claim 10, wherein at least one groove is disposed on one of the at least two ring segments and the at least two sprocket body members.

14. The split sprocket assembly of claim 13, wherein at least one projection for engaging with the groove is disposed on one of the at least two ring segments and the at least two sprocket body members.

15. The split sprocket assembly of claim 10, wherein the plurality of sprocket teeth extend along the periphery of the at least two ring segments.

16. A split sprocket assembly, comprising:
at least two sprocket body members having a first side defining a portion of an opening for receiving a shaft and having a second side disposed opposite from the first side, the second side having a plurality of walls extending therefrom, the walls disposed substantially parallel to each other and in spaced apart relation such that they define channels;
at least two ring segments having a plurality of sprocket teeth disposed along the periphery thereof, each ring segment having a first end and a second end, the at least two ring segments being disposed inside the channels in the at least two sprocket body members;
a projection disposed on one of the at least two ring segments and the at least two sprocket body members;
a groove capable of engaging with the projection disposed on one of the at least two ring segments and the at least two sprocket body members; and,
wherein the sprocket body members are capable of being juxtaposed around a shaft and held in position by connection of the at least two ring segments in end-to-end fashion.

17. The split sprocket assembly of claim 16, wherein the ring segments and the walls further comprise alignment openings for receiving a pin to hold the sprocket body member and ring segment together in alignment.
